(19) United States
(12) Patent Application Publication
(10) Pub. No.: US 2007/0217434 A1
(43) Pub. Date: Sep. 20, 2007

(54) Method for configuring remote IP phones

(75) Inventor: Robert Welbourn, Newton, MA (US)

Correspondence Address: FOLEY AND LARDNER LLP;SUITE 500, 3000 K STREET NW, WASHINGTON, DC, 20007, US

(73) Assignee: Aastra Technologies Ltd.

(21) Appl. No.: 11/374,152

(22) Filed: Mar. 14, 2006

(51) Int. Cl. H04L 12/56; H04L 12/28

(52) U.S. Cl. 370/401; 370/254

(57) ABSTRACT

A system and method for configuring a communication device such as IP phone to operate in central and remote networks is disclosed. A central network includes an Internet Gateway Device, an Internet Protocol Private Branch Exchange (IP PBX) and a communication device. The communication device downloads and stores a configuration file including the externally-visible IP address or unique host name of the IP PBX. Upon installation in a remote network, the communication device uses its configuration file to locate the IP PBX and configure itself automatically for use in the remote network.

### BACKGROUND OF THE INVENTION

Voice over Internet Protocol (VoIP) is a technology that provides voice services over an Internet Protocol (IP) network. An IP network differs from conventional telephone networks in that speech is transmitted using packet switching technology rather than dedicated voice circuits.

In VoIP networks, communication devices such as IP phones are typically used to make and receive calls, with the call control logic residing in IP equivalents of private branch exchanges (PBXs) or telephone company central office switches. As illustrated in FIG. 1, an IP phone may be used in various network configurations. FIG. 1 shows an exemplary local/central 3 and remote 2 network configuration for a communication device 10 such as an IP phone. In a central network 3, IP phones 10 are connected to an IP PBX 40. The IP PBX 40 is connected to an Internet Gateway Device (IGD) 30. The IP PBX 40 routes call signaling information to and from the IP phones 10. Once the call has been set up, the IP phones 10 at the central network then pass the packetized speech directly from one IP phone 10 to another. In a remote network 2, IP Phones 10 are connected directly to the IGD 30. Thus, both call signaling and speech traffic is routed directly through the IGD 30.

IGDs 30 are commonly used as firewalls and hide the IP addressing scheme used at a site from the wider Internet. Firewalls commonly allow devices to make outgoing connections to external services, but restrict incoming connections. As illustrated in FIG. 1, in order for the IP phone 10 at remote site 2 to send signaling traffic to the IP PBX 40 at central site 3, it must send the traffic through the IGD 30 at remote site 2 and through the Internet 4 to the IGD 30 at central site 3. The IGD 30 at central site 3 must be preconfigured or otherwise instructed to forward the signaling traffic to the IP PBX 40. So far as the IP phone 10 at remote site 2 is concerned, it is sending the signaling traffic to a public IP address and port at the IGD 30 at central site 3; the details of the central site IP addressing scheme are opaque to the IP phone 10 at remote site 2. Note that a separate port is required at the IGD 30 for each distinct service provided by the IP PBX 40, including but not limited to call signaling, phone configuration, phone display control and forwarding of the packetized speech.

An IP phone 10 must be configured properly to operate in a central 3 or remote 2 network. Generally, the procedure consists of installing configuration files on the IP phone 10 which direct the IP phone 10 to route its signaling traffic to an IP PBX 40. The configuration settings for an IP phone 10 operating in a central network 3 are different from a remote IP phone 10 configuration; at the central site 3, the IP phones 10 send signaling traffic directly to the IP PBX 40, whereas at the remote site 2 the signaling traffic must transit the IGDs 30. Accordingly, IP phones 10 are generally configured to operate in one of the two environments but not both. When an IP phone 10 is moved from one network environment to another it must be reconfigured. This reconfiguration can be an error-prone and time consuming process. Moreover, reconfiguration requires a level of technical proficiency which cannot be expected of ordinary phone users.

Many central networks are implemented so that the IGD's 30 public IP address is allocated dynamically by an Internet service provider. Having a dynamic IP address is a cost-effective solution for many small businesses, because Internet service providers typically charge a premium for permanent IP addresses. However, a remote IP Phone 10 in communication with the IGD 30 must be reconfigured each time the IGD's IP address changes.

Thus, there is a need for a system and method for configuring communication devices such as IP phones so that they may operate in different network environments without a lengthy and complex reconfiguration process. In addition, there is a need for a system and method for configuring communication devices such as IP phones for use in networks having a dynamic IP address.

### SUMMARY OF THE INVENTION

According to one embodiment of the invention, a method for configuring a communication device comprises providing a central network including at least one central IP PBX configured to execute a service discovery protocol, a central IGD operatively connected to the central IP PBX and a communication device, operatively connected to the central IP PBX, configured to transmit and receive information via IP. The method further comprises discovering a central IGD using the service discovery protocol, configuring the central IGD to operate with the central IP PBX, distributing a configuration file provided by the central IP PBX to the communication device, wherein the configuration file includes an externally-visible IP address and one or more ports associated with the various services provided by the central IP PBX, and saving the configuration file to the communication device in non-volatile memory.

According to another embodiment of the invention, a method for configuring a communication device comprises removing the communication device from the central network and providing a remote network, including a remote IGD and the communication device operatively connected to the remote IGD. The method further comprises having the communication device determine whether it is centrally or remotely located by attempting to discover the IP PBX in its local network environment; and if the IP PBX is not present in the local network environment, using the externally-visible IP address and ports in the configuration file stored in the non-volatile memory of the communication device to communicate with the central IP PBX through the remote IGD.

According to yet another embodiment of the invention, a method for configuring a communication device comprises providing a central network including at least one central IP PBX configured to execute a service discovery protocol, a central IGD, having a dynamic public IP address, operatively connected to the central IP PBX and a communication device, operatively connected to the central IP PBX, configured to transmit and receive information via IP. The method further comprises discovering a central IGD using the service discovery protocol, configuring the central IGD to operate with the central IP PBX, distributing a configuration file provided by the central IP PBX to the communication device, wherein the configuration file includes the unique host name of the IP PBX, and one or more ports associated with the various services provided by the central IP PBX, and saving the configuration file to the communication device in a non-volatile memory.

According to still another embodiment of the invention, a method for configuring a communication device comprises removing the communication device from the central network and providing a remote network, including a remote IGD and the communication device operatively connected to the remote IGD. The method further comprises having the communication device determine whether it is centrally or remotely located by attempting to discover the IP PBX in its local network environment; and if the IP PBX is not present in the local network environment, using the unique host name in the configuration file stored in the non-volatile memory of the communication device to perform a Domain Name System (DNS) lookup to find the external, public IP address at the IGD that will allow the communication device to communicate with the central IP PBX, and to use that IP address along with the ports stored in the configuration file.

It is to be understood that both the foregoing general description and the following detailed description are exemplary and explanatory only, and are not restrictive of the invention as claimed.

### BRIEF DESCRIPTION OF THE DRAWINGS

Features, aspects and advantages of the present invention will become apparent from the following description, appended claims, and the accompanying exemplary embodiments shown in the drawings, which are briefly described below.

FIG. 1 is a schematic diagram of a remote network and a central network connected via the Internet.

FIG. 2(a) is a flowchart of a method for configuring a communication device to operate both at a central network and at a remote network using a centrally located IP PBX, according to one embodiment of the invention.

FIG. 2(b) is a flowchart of a method for configuring an IGD, according to one embodiment of the invention.

FIG. 2(c) is a flowchart of a method for acquiring a configuration file from a centrally located IP PBX using a previously unconfigured communication device located at a central site, according to one embodiment of the invention.

FIG. 2(d) is a flowchart of a method for updating the configuration of a communication device, previously having obtained its configuration at a central site, in a either a central or a remote network, according to one embodiment of the invention.

FIG. 3 is a flowchart of a method for updating the externally visible IP address of the IP PBX with a dynamic DNS service, according to one embodiment of the invention.

### DETAILED DESCRIPTION OF THE PREFERRED EMBODIMENTS

Embodiments of the present invention will be described below with reference to the accompanying drawings. It should be understood that the following description is intended to describe exemplary embodiments of the invention, and not to limit the invention.

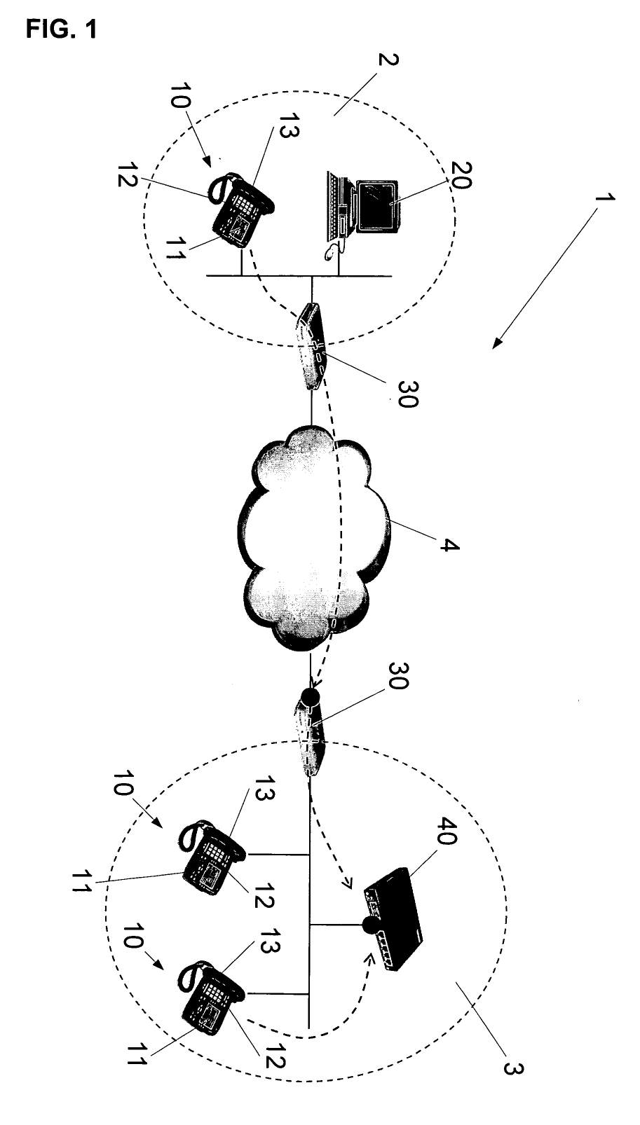

FIG. 1 is a schematic representation of a communications network 1. The communications network 1 uses the Internet Protocol (IP) to transmit and receive information via packet switching over the Internet 4. According to one embodiment, the communications network, shown in FIG. 1, consists of a remote private IP address space or network 2 connected to a local/central private IP address space or network 3 via the Internet 4. It should be understood that the communications network 1 may consist of a plurality of remote and central networks and that one of each is shown here for simplicity.

Each private network includes a number of devices. For example, the remote private network 2 shown in FIG. 1 includes a communication device 10, a computer 20 and an Internet gateway device (“IGD”) 30. The communication device 10, computer 20 and IGD 30 are all operatively connected to each other via the network to facilitate the transmission of data. Preferably, the communication device 10 is a phone configured to transmit and receive information via packet switching. The phone 10 may be equipped with an IP terminal adapter (not shown) or may be an IP phone. The communication device includes several components. As shown in FIG. 1, the communication device 10 may have a screen 11 for displaying information to a user. The communication device 10 also includes a set of programmable keys 12 to allow the user to input information or commands. In addition, the communication device 10 also includes a handset 13 for receiving and transmitting audible signals.

The IGD 30 is a computer networking device that transfers data between a local area network 2 or 3 and the Internet 4, or other devices or networks connected to the Internet 4. Preferably, the IGD 30 is a firewall configured to execute Network Address Translation (NAT). NAT allows multiple hosts on each of the private networks to access the Internet 4 via a single external IP address. The remote IGD 30 and the central IGD 30 are each associated with an externally-visible IP address. Generally, for large enterprises the externally-visible IP address for the IGD 30 is static. However, some networks are configured wherein the externally-visible IP address of the IGD 30 is dynamic.

As shown in FIG. 1, the central IGD 30 is an access node for the central private network 3. According to one embodiment of the invention, the central private network 3 consists of one or more communication devices 10 and one or more IP PBXs 40. Preferably, the central communication device 10 is a phone configured to transmit and receive information via packet switching. The phone may be equipped with an IP adapter (not shown) or may be an IP phone 10.

As shown in FIG. 1, the IP PBX 40 is a device used for routing call signaling and speech traffic between one or more communication devices 10 within the central network 3, and optionally one or more communication devices 10 at remote sites 2. The IP PBX 40 is the central point of exchange of all call signaling traffic, but where practical will direct the communication devices 10, by means of information contained in the signaling traffic, to transmit speech traffic directly to each other. The IP PBX 40 has a private IP address, and may also have an associated host name that can be used with the Domain Name System (DNS) to translate the name into an IP address. The communication devices 10 at the central site 3 use this private IP address (or the host name) to communicate with the IP PBX 40. The IP PBX 40 may in addition act as a relay point for speech traffic entering or exiting the network via the IGD 30, thereby allowing it also to function as a security control point. For devices outside the central communication network 3, the IP address of the central IP PBX 40 is seen as the external, public IP address of the central IGD 30. (There may in addition be an associated host name that can be used to obtain the IP address via a DNS look-up.) Accordingly, the central IP PBX's 40 externally-visible IP address is the central IGD's 30 IP address. Thus, transmitted information intended for the central IP PBX 40 from a device outside the central network 3 is first routed to the central IGD 30 and then to the private IP address which identifies the desired central IP PBX 40.

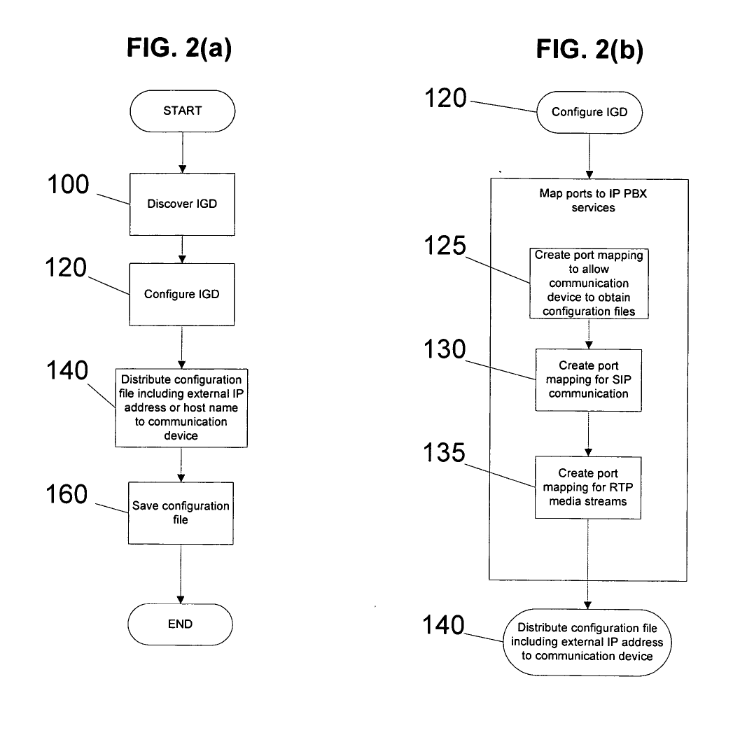

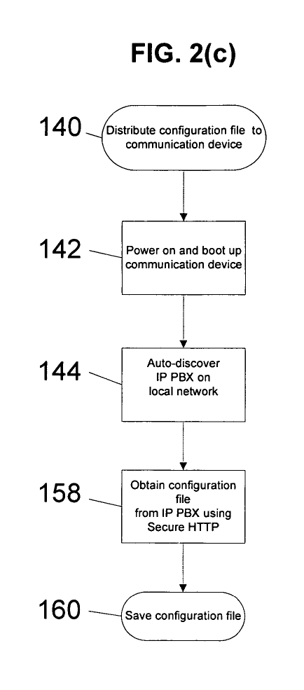

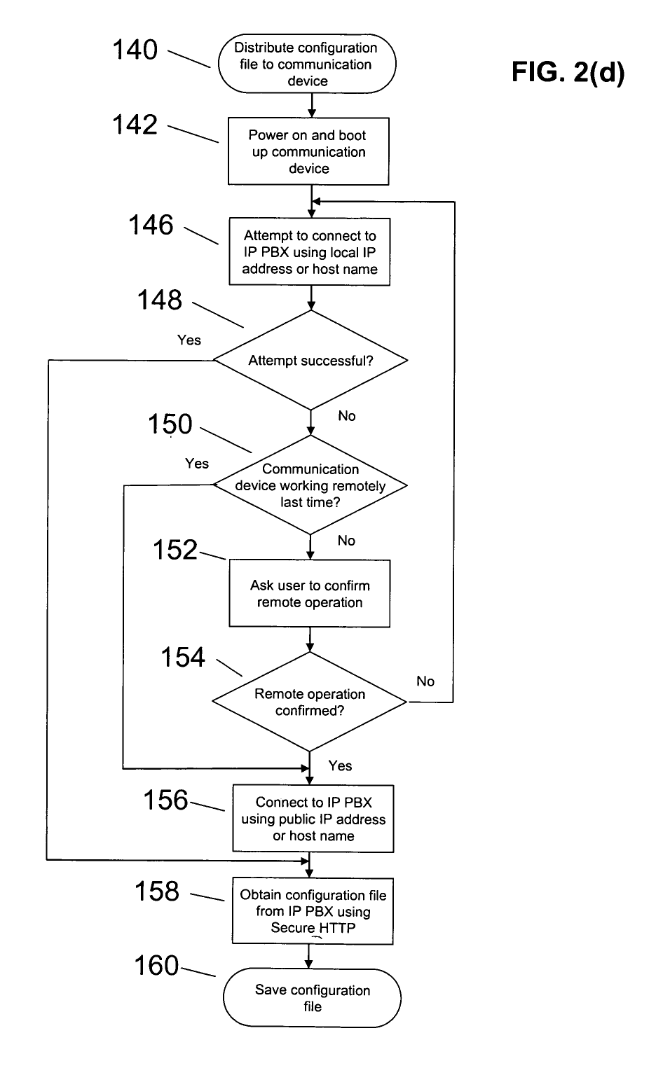

A system and method for configuring a communication device 10 will now be described. First, as shown in FIG. 1, a central communications network 3 is provided. Next, as shown in FIG. 2(a), the central IP PBX 40 uses a discovery protocol to discover the central IGD 30 and its external IP address (Step 100). An example of such a discovery protocol is the Universal Plug'n'Play protocol (“UPnP”), which allows for the automated identification and cooperation of various network devices on the same network. As an alternative, the central IP PBX 40 and central IGD 30 may be configured manually.

Next, the central IP PBX 40 directs the central IGD 30 to map various Transport Control Protocol (TCP) and/or User Datagram Protocol (UDP) ports to services running on the central IP PBX 40 (Step 120). These mappings allow a device accessing the central IP PBX 40 through the central IGD 30 to communicate with various services or programs running on the central IP PBX 40. As shown in FIG. 2(b), for example, a port mapping is created to allow a communication device 10 to obtain configuration files from the central IP PBX 40 (Step 125). A second port mapping is created for the Session Initiation Protocol (“SIP”; Step 130). SIP is well known as a signaling protocol for Voice over IP communications. In step 135, a port mapping for Real-time Transport Protocol (RTP) is established. RTP is a standard protocol for delivering video and audio.

Next, as shown in step 140, a configuration file which includes the externally-visible IP address (and/or host name) is downloaded to the communication device 10. The download process is carried out as shown in FIG. 2(c). First, the communication device 10 is powered on and boots up (Step 142). Next, the communication device 10 discovers the central IP PBX 40 (Step 144) using a service discovery protocol. According to one embodiment of the invention, the communication device 10 uses the DNS Service Discovery protocol (DNS-SD) to locate a central IP PBX 40 on the private central network 3; according to another embodiment, the communication device 10 uses the UPnP protocol. If more than one central IP PBX 40 is located, a user is given the option of choosing one central IP PBX 40 for the purposes of configuration.

As shown in step 158, the communication device 10 uses the Secure Hypertext Transport Protocol (HTTPS) to obtain the configuration file. According to another embodiment of the invention the communication device uses an unencrypted HTTP request to obtain the configuration file. As a parameter to the HTTPS or HTTP request, the communication device 10 supplies its Media Access Control (MAC) address. The communication device's 10 MAC address is a unique identifier that is used by the central IP PBX 40 to download the correct configuration file to the communication device 10.

The configuration file includes items such as: security credentials for communicating with the IP PBX 40; the internal IP address or host name of the IP PBX 40; the externally-visible IP address or unique host name of the central IP PBX 40; and sets of TCP and/or UDP ports linked to both the private internal IP address (or host name) and the externally-visible IP address (or unique host name) of the IP PBX 40 that allow a communication device 10 to obtain an updated configuration from the IP PBX 40, facilitate SIP communication with the IP PBX 40, and perform other actions such as displaying at the communication device 10 the output from applications or information services running on the IP PBX 40. In addition, the configuration file may include text to display permanently on the screen 11 of the communication device 10, such as its extension number and the name of the subscriber, and it may also contain information governing the actions of the communication device's 10 programmable keys 12, if any.

Finally, as shown in FIG. 2(a), the configuration file is saved on the communication device 10 in non-volatile memory (Step 160). The communication device 10 is now ready for use either at the central site 3 or the remote site 2, as it has all the information it needs to communicate directly with the IP PBX 40 using its private IP address or host name, or via the central IGD 30 using its public IP address or host name.

The operation of a communication device 10 at a remote network location will now be described with reference to FIG. 2(d). First, according to one embodiment of the invention, a remote location as illustrated by the private remote network 2 in FIG. 1 is provided. The private network 2 includes a remote IGD 30. A communication device 10 configured as described in FIGS. 2(a)-(c) is operatively placed in the network, powered on and booted up (Step 142). Next, as shown in step 146, the communication device 10 determines if an IP PBX 40 is present on its local network 2. It does this by attempting to connect to the IP PBX 40 at the local IP address or host name previously saved in the communication device's 10 configuration file.

If the communication device 10 fails to get a response from the IP PBX 40, then the communication device 10 connects remotely to the central IP PBX 40 identified by the externally-visible IP address or unique host name saved in the communication device's 10 memory (Step 156). According to one embodiment of the invention, a user is prompted before the communication device 10 attempts to communicate with the central IP PBX 40 (Step 152). This confirmatory step is taken because some temporary network or other operational problem might otherwise cause a communication device 10 operating at the central network 3 to incorrectly attempt to use the external IP address or host name to contact the IP PBX 40. Once it has been established that the communication device is located at the remote network 2, this confirmatory step is omitted for subsequent boot-ups of the phone. The communication device 10 then sends an HTTPS request for an updated configuration file to the central IP PBX 40 (Step 158). In return, the communication device 10 receives an updated configuration file from the central IP PBX 40.

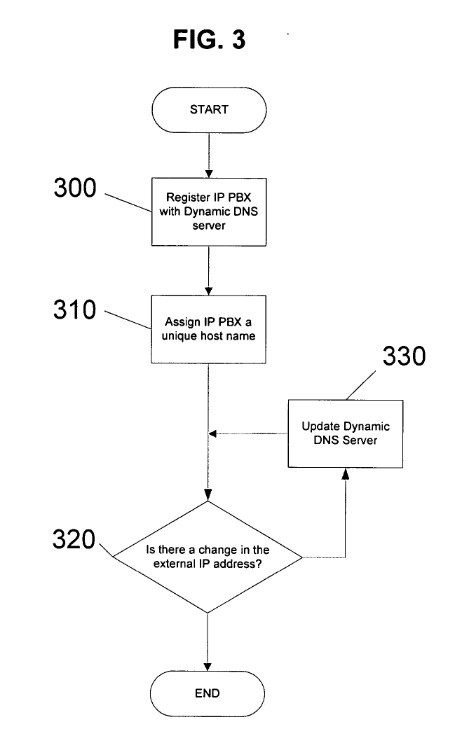

The method for operating a communication device 10 where the central site network has an IGD 30 with a dynamic IP address will now be described. First, a communications network having at least one central IP PBX 40, communication device 10 and central IGD 30 is provided, as shown in FIG. 1. As shown in FIG. 3 step 300, the central IP PBX 40 is registered with a Dynamic DNS server (not shown). Then, the central IP PBX's 40 externally-visible IP address is associated with a fully qualified domain name consisting of a unique host name appended with a domain name, for example ippbx123456.AastraConnect.com (Step 310). This allows devices connected to the network to communicate with the central IP PBX 40 using its fully qualified domain name. Thus, even if the central IP PBX's 40 externally-visible IP address is changed it can be located using its fully qualified domain name.

The IP PBX 40 continuously monitors the externally-visible IP address of the central IGD 30 (Step 320). If the externally-visible IP address changes, then the central IP PBX 40 updates the dynamic DNS server (not shown) with the new IP address information (Step 330).

FIG. 2(d) also illustrates the operation of a communication device 10 at a remote location when a dynamic IP address is in use. The method of operation when using a dynamic external IP address works in exactly the same manner as using a static external IP address for the IGD 30, with respect to the configuration of the IGD 30, the auto-discovery by the communication devices 10 of the IP PBX 40 and the downloading of the configuration files from the IP PBX 40 to the communication devices 10, whether located centrally or remotely. The one exception is that remote communication devices 10 must always use the fully qualified domain name to look up the public IP address of the IP PBX 40, as illustrated in FIG. 2(d) (Step 156) and must not use the IP address directly.

According to any one aspect of the invention, several advantages are realized. First, devices present on a network are able to discover other devices on the network without manual intervention, whether they are locally or remotely located. Notably, communication devices 10 configured at a central location 3 and then deployed remotely do not require reconfiguration on the remote network 2. This eliminates time-consuming reconfiguration processes. In addition, IP PBXs 40 and communication devices 10 configured by the disclosed methods can be used in almost any standard network, whether using static or dynamic IP addressing. The ability of IP PBXs 40 and communication devices 10 to operate in a dynamic IP address environment further reduces costs by allowing cheaper broadband connections with dynamic IP addresses to be used, and using less-expensive dynamic DNS services in place of service provider VoIP infrastructure, which would otherwise be needed to relay VoIP traffic between sites with changeable IP addresses.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A method for configuring a communication device, comprising:
providing a central network including:
at least one Internet Protocol private branch exchange (IP PBX) configured to execute a service discovery protocol;
a central Internet gateway device (IGD) operatively connected to the IP PBX; and
a communication device, operatively connected to the IP PBX, configured to transmit and receive information via the Internet Protocol;
discovering the central IGD using the service discovery protocol;
configuring the central IGD to operate with the IP PBX;
distributing a configuration file provided by the IP PBX to the communication device, wherein the configuration file includes an externally-visible IP address or host name associated with the IP PBX and one or more ports associated with services provided by the IP PBX; and
saving the configuration file to the communication device in non-volatile memory.

2. The method as claimed in claim 1, wherein the configuring step further comprises:
determining the externally-visible IP address of the IP PBX;
creating a port mapping in the IGD to allow a communication device to obtain its configuration file using the Secure Hypertext Transfer Protocol (HTTPS);
creating a port mapping in the IGD to facilitate Session Initiation Protocol (SIP) communication with the IP PBX; and
creating a port mapping in the IGD to facilitate real-time transport protocol (RTP) media communication with the IP PBX.

3. The method as claimed in claim 1, wherein the distributing step further comprises:
locating all the IP PBXs on the central network;
if there is more than one IP PBX, selecting one IP PBX for configuration download; and
executing an HTTPS request, wherein a media access control (MAC) address of the communication device is provided to the IP PBX, to retrieve the configuration file from the IP PBX and send it to the communication device.

4. The method of claim 1, further comprising:
removing the communication device from the central network;
providing a remote network, including:
a remote IGD; and
the communication device operatively connected to the remote IGD;
determining whether the IP PBX is present on the network, to determine whether the communication device is operating locally at the central network or remotely;
if the IP PBX is not present on the network, using the externally-visible IP address or host name and ports in the configuration file stored in the non-volatile memory of the communication device to access the IP PBX remotely through the remote and central IGDs; and
distributing an updated configuration file provided by the IP PBX to the communication device.

5. A method of configuring a communication device, comprising:
providing a central network including:
at least one Internet protocol private branch exchange (IP PBX) configured to execute a service discovery protocol;
a central Internet gateway device (IGD), having a dynamic IP address, operatively connected to the IP PBX; and
a communication device, operatively connected to the IP PBX, configured to transmit and receive information via the Internet Protocol;
discovering a central IGD using the service discovery protocol;
configuring the central IGD to operate with the IP PBX;
distributing a configuration file provided by the IP PBX to the communication device, wherein the configuration file includes the unique host name of the IP PBX and one or more ports associated with various services provided by the IP PBX; and
saving the configuration file to the communication device in non-volatile memory.

6. The method of claim 5, further comprising the steps of:
monitoring the central IGD's external IP address; and
if the central IGD's external IP address changes, updating a dynamic DNS service with the new external IP address.

7. The method of claim 5, further comprising:
removing the communication device from the central network;
providing a remote network, including:
a remote IGD; and
the communication device operatively connected to the remote IGD;
determining whether the IP PBX is present on the network, to determine whether the communication device is operating locally at the central network or remotely;
if a remote IP PBX is not present on the remote network, using the unique host name in the configuration file stored in the non-volatile memory of the communication device to perform a DNS lookup to find the external, public IP address at the IGD that will allow the communication device to communicate with the IP PBX; and
distributing an updated configuration file including the external IP address and ports provided by the IP PBX to the communication device.

8. A system for configuring an IP phone for use in a remote network, comprising:
at least one Internet protocol private branch exchange (IP PBX) configured to execute a service discovery protocol;
a central Internet gateway device (IGD) operatively connected to the IP PBX; and
an IP phone, operatively connected to the IP PBX, configured to transmit and receive information via the Internet Protocol; wherein
the IP PBX discovers the central IGD using the service discovery protocol and configures the central IGD to operate with the IP PBX;
the IP phone acquires a configuration file provided by the IP PBX, the configuration file including an externally-visible IP address or host name associated with the IP PBX and one or more ports associated with services provided by the IP PBX; and
the IP phone saves the configuration file in a non-volatile memory.

9. A system for configuring an IP phone for use in a remote network, comprising:
at least one Internet protocol private branch exchange (IP PBX) configured to execute a service discovery protocol;
a central Internet gateway device (IGD), having a dynamic IP address, operatively connected to the IP PBX; and
a communication device, operatively connected to the IP PBX, configured to transmit and receive information via the Internet Protocol; wherein
the IP PBX discovers the central IGD using the service discovery protocol and configures the central IGD to operate with the IP PBX;
the IP phone acquires a configuration file provided by the IP PBX, wherein the configuration file includes the unique host name of the IP PBX and one or more ports associated with various services provided by the IP PBX; and
the IP phone saves the configuration file in a non-volatile memory.
